(19) United States
(12) Patent Application Publication
(10) Pub. No.: US 2025/0346054 A1
(43) Pub. Date: Nov. 13, 2025

(54) LIQUID DISCHARGE SYSTEM, LIQUID DISCHARGE APPARATUS, AND LIQUID DISCHARGE METHOD

(71) Applicant: Toshifumi MURAI, Tokyo (JP)

(72) Inventor: Toshifumi MURAI, Tokyo (JP)

(21) Appl. No.: 19/194,001

(22) Filed: Apr. 30, 2025

(30) Foreign Application Priority Data
May 8, 2024 (JP) 2024-076140

(51) Int. Cl. B41J 29/377; B41J 2/045; B41J 2/17; B41J 11/00; B41J 15/04

(52) U.S. Cl. CPC B41J 29/377; B41J 2/04563; B41J 2/04566; B41J 2/1714; B41J 11/0024; B41J 2/04586; B41J 15/048

(57) ABSTRACT

A liquid discharge system includes multiple liquid discharge apparatuses, a detector, an exhaust device, multiple exhaust ducts, multiple shutters, and circuitry. The multiple liquid discharge apparatuses discharge a liquid. The detector detects an operation state of each of the multiple liquid discharge apparatuses. The exhaust device exhausts air from each of the multiple liquid discharge apparatuses. The multiple exhaust ducts respectively connect the multiple liquid discharge apparatuses to the exhaust device. The multiple shutters respectively adjust an air volume of the air exhausted through the multiple exhaust ducts. The circuitry controls each of the multiple shutters to change an opening size of corresponding one of the multiple shutters based on the operation state detected by the detector and controls the exhaust device to change the air volume based on the operation state.

### CROSS-REFERENCE TO RELATED APPLICATION

This patent application is based on and claims priority pursuant to 35 U.S.C. § 119(a) to Japanese Patent Application No. 2024-076140, filed on May 8, 2024, in the Japan Patent Office, the entire disclosure of which is hereby incorporated by reference herein.

### BACKGROUND

### Technical Field

The present disclosure relates to a liquid discharge system, a liquid discharge apparatus, and a liquid discharge method.

### Related Art

A liquid discharge apparatus discharges a liquid to perform printing. The liquid discharge apparatus may include a heating unit that heats the liquid such as ink discharged onto, for example, a continuous sheet. The generated vaporized liquid or water vapor is exhausted from the liquid discharge apparatus.

### SUMMARY

The present disclosure described herein provides an improved liquid discharge system including multiple liquid discharge apparatuses, a detector, an exhaust device, multiple exhaust ducts, multiple shutters, and circuitry. The multiple liquid discharge apparatuses discharge a liquid. The detector detects an operation state of each of the multiple liquid discharge apparatuses. The exhaust device exhausts air from each of the multiple liquid discharge apparatuses. The multiple exhaust ducts respectively connect the multiple liquid discharge apparatuses to the exhaust device. The multiple shutters respectively adjust an air volume of the air exhausted through the multiple exhaust ducts. The circuitry controls each of the multiple shutters to change an opening size of corresponding one of the multiple shutters based on the operation state detected by the detector and controls the exhaust device to change the air volume based on the operation state.

Further, the present disclosure described herein provides an improved liquid discharge apparatus including an image forming unit, a heating unit, a detector, multiple exhaust ducts, multiple shutters, and circuitry. The image forming unit discharges a liquid onto an object to forms an image on the object. The heating unit heats the object onto which the liquid has been discharged. The detector detects an operation state of each of the image forming unit and the heating unit. The exhaust device exhausts air from each of the image forming unit and the heating unit. The multiple exhaust ducts respectively connect the image forming unit and the heating unit to the exhaust device. The multiple shutters respectively adjust an air volume of the air exhausted through the multiple exhaust ducts. The circuitry controls each of the multiple shutters to change an opening size of corresponding one of the multiple shutters based on the operation state detected by the detector and controls the exhaust device to change the air volume based on the operation state.

Further, the present disclosure described herein provides an improved liquid discharge method including causing multiple liquid discharge apparatuses to discharge a liquid, detecting an operation state of each of the multiple liquid discharge apparatuses, exhausting air from each of the multiple liquid discharge apparatuses, causing multiple shutters to respectively adjust an air volume of the air exhausted from the multiple liquid discharge apparatuses, changing an opening size of each of the multiple shutters based on the operation state, and changing the air volume based on the operation state.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a liquid discharge system according to a first embodiment of the present disclosure;

FIG. 2 is a schematic view of a liquid discharge apparatus;

FIG. 3 is a schematic view of a drying device;

FIG. 4 is a block diagram illustrating a hardware configuration of a liquid discharge apparatus;

FIG. 5 is a block diagram illustrating a hardware configuration of an information processing apparatus;

FIG. 6 is a block diagram illustrating a functional configuration of an information processing apparatus according to the first embodiment;

FIG. 7 is a flowchart of a control procedure in the liquid discharge system of FIG. 1, according to the first embodiment;

FIGS. 8A to 8D are diagrams each illustrating control of a shutter and an exhaust device;

FIG. 9 is a diagram illustrating a configuration of a liquid discharge system according to a second embodiment of the present disclosure;

FIG. 10 is a block diagram illustrating a functional configuration of an information processing apparatus according to the second embodiment;

FIG. 11 is a flowchart of a procedure of failure detection by a failure detector;

FIG. 12 is a diagram illustrating a configuration of a liquid discharge system according to a third embodiment of the present disclosure;

FIG. 13 is a block diagram illustrating a functional configuration of an information processing apparatus according to the third embodiment;

FIGS. 14A and 14B are a flowchart of a control procedure in the liquid discharge system of FIG. 12, according to the third embodiment;

FIG. 15 is a schematic view of a liquid discharge apparatus according to a fourth embodiment of the present disclosure, illustrating a configuration relating to an exhaust process;

FIG. 16 is a block diagram illustrating a functional configuration of the liquid discharge apparatus of FIG. 15, according to the fourth embodiment; and

FIG. 17 is a flowchart of a procedure of exhaust control in the liquid discharge apparatus of FIG. 15, according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus discharges a liquid to perform printing. The liquid discharge apparatus may include a heating unit that heats the liquid such as ink discharged onto, for example, a continuous sheet. The generated vaporized liquid or water vapor is exhausted from the liquid discharge apparatus.

When air is exhausted from multiple liquid discharge apparatuses, one exhaust device may be connected to the multiple liquid discharge apparatuses to perform the exhaust. In such a case, in a comparative example, if even one liquid discharge apparatus connected to the exhaust device is printing, the same volume of air is exhausted from the other liquid discharge apparatuses on standby, from which the air is not required to be exhausted. As a result, power consumption is not reduced.

Embodiments of a liquid discharge system, a liquid discharge apparatus, and a liquid discharge method are described in detail below with reference to the accompanying drawings.

### First Embodiment

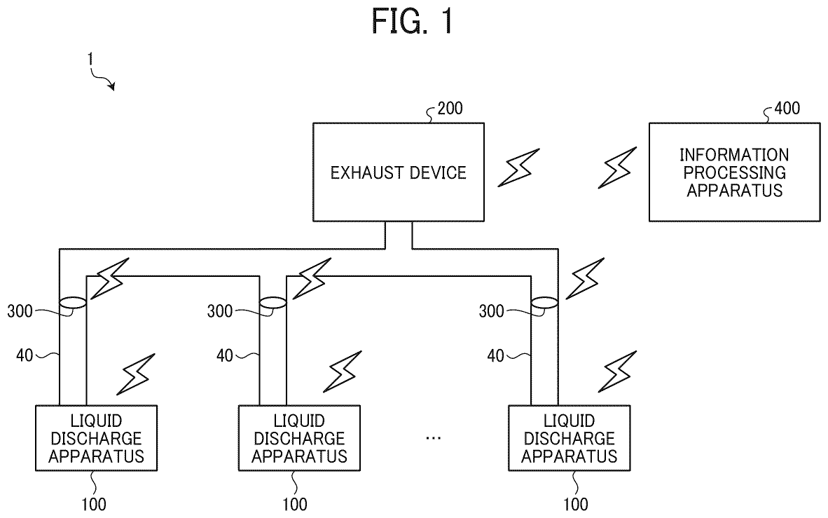

FIG. 1 is a diagram illustrating a configuration of a liquid discharge system 1 according to a first embodiment of the present disclosure. The liquid discharge system 1 includes an exhaust device 200, multiple liquid discharge apparatuses 100, exhaust ducts 40 that connect the exhaust device 200 and the multiple liquid discharge apparatuses 100, shutters 300 respectively installed in the exhaust ducts 40, and an information processing apparatus 400. The multiple liquid discharge apparatuses 100, the exhaust device 200, the multiple shutters 300, and the information processing apparatus 400 are connected to each other via a wired or wireless connection to communicate with each other. One of the multiple liquid discharge apparatuses 100 may be a master apparatus in which the information processing apparatus 400 is installed.

The liquid discharge apparatus 100 is, for example, an inkjet recording apparatus that discharges ink of a desired color onto a medium (object) onto which liquid can adhere, as described later. The exhaust duct 40 connected to each liquid discharge apparatus 100 guides the vaporized liquid and water vapor generated in the liquid discharge apparatus 100 to the exhaust device 200 which is shared by the multiple liquid discharge apparatuses 100. Each shutter 300 changes the area and size of an opening (i.e., an opening size) of the exhaust duct 40 in multiple levels (for example, two or more levels) to change the volume of exhaust air (i.e., an exhaust air volume which may be referred to simply as an air volume) exhausted by each corresponding exhaust duct 40. The shutter 300 may be, for example, a damper or a diaphragm that can continuously change the opening size.

The exhaust device 200 exhausts air, for example, including the vaporized liquid and water vapor from the multiple liquid discharge apparatuses 100 via the multiple exhaust ducts 40. The information processing apparatus 400 controls the adjustment of the opening sizes of the multiple shutters 300 and the change of the exhaust air volume of the exhaust device 200. These controls are performed based on an operation state of the liquid discharge apparatuses 100 to reduce power consumption of the exhaust device 200, as described later.

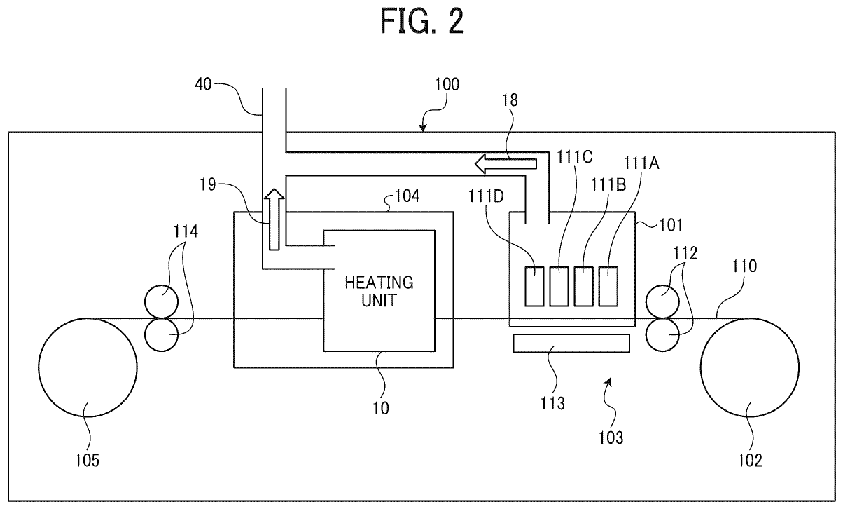

FIG. 2 is a schematic view of the liquid discharge apparatus 100. The liquid discharge apparatus 100 includes a liquid discharge unit 101 that discharges a liquid onto a continuous sheet 110 as a medium (object) onto which liquid can adhere.

The liquid discharge unit 101 includes, for example, heads 111A, 111B, 111C, and 111D for four colors from the upstream side in the conveyance direction of the continuous sheet 110. The heads 111A, 111B, 111C, and 111D may be collectively referred to as “heads 111,” each of which may be referred to as a “head 111.” The heads 111 may be full-line heads or serial heads. The heads 111A, 111B, 111C, and 111D discharge liquids (e.g., inks) of black K, cyan C, magenta M, and yellow Y onto the continuous sheet 110, respectively. The number and types of colors are not limited to the above-described four colors of K, C, M, and Y and may be any other suitable number and types. The head 111 may be referred to as a liquid discharge head.

The continuous sheet 110 is fed from a feeding roller 102, is sent onto a conveyance guide 113 by conveyance rollers 112 of a conveyor 103, and is guided and conveyed by the conveyance guide 113. The conveyance guide 113 faces the liquid discharge unit 101. The continuous sheet 110 onto which the liquid is discharged by the liquid discharge unit 101 passes a drying device 104, is sent by ejection rollers 114, and is wound around a winding roller 105.

The exhaust duct 40 exhausts air from a heating unit 10 and the liquid discharge unit 101. Specifically, as illustrated in FIG. 2, the exhaust duct 40 is branched into two ducts in the liquid discharge apparatus 100, one of the two ducts exhausts a vapor 19 generated in the heating unit 10, and the other duct exhausts an ink mist 18 generated in the liquid discharge unit 101.

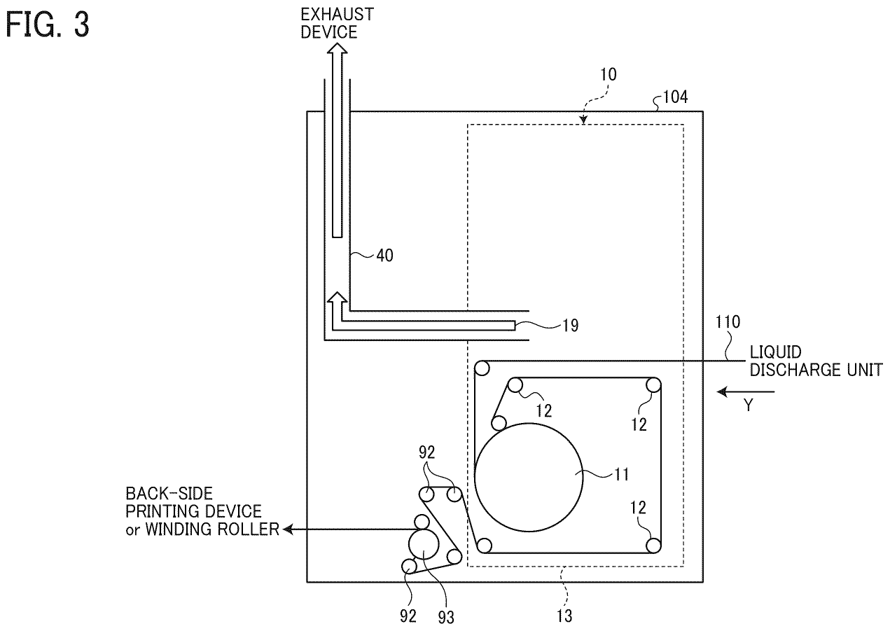

The drying device 104 is described below with reference to FIG. 3. FIG. 3 is a schematic view of the drying device 104. The drying device 104 includes the heating unit 10, a conveyance drive roller 93, and multiple driven rollers 92. The heating unit 10 heats and dries the continuous sheet 110 conveyed from the liquid discharge unit 101 in the direction indicated by an arrow Y. One of the two branched ducts of the exhaust duct 40 is coupled to the heating unit 10 to guide the vapor 19 exhausted from the heating unit 10.

The heating unit 10 includes a heat drum 11 that heats the continuous sheet 110 and multiple guide rollers 12 that guide the continuous sheet 110 around the heat drum 11 in a housing 13. The continuous sheet 110 that has passed through the heating unit 10 is guided and conveyed by the conveyance drive roller 93 and the multiple driven rollers 92, and is sent to a back-side liquid discharge apparatus or the winding roller 105.

The exhaust duct 40 guides the vapor 19 containing a solvent and water vapor generated when the continuous sheet 110 is dried by the heating unit 10 toward the exhaust device 200. In the liquid discharge apparatus 100 as described above, the exhaust device 200 exhausts the vapor 19 and the ink mist 18 guided by the exhaust duct 40.

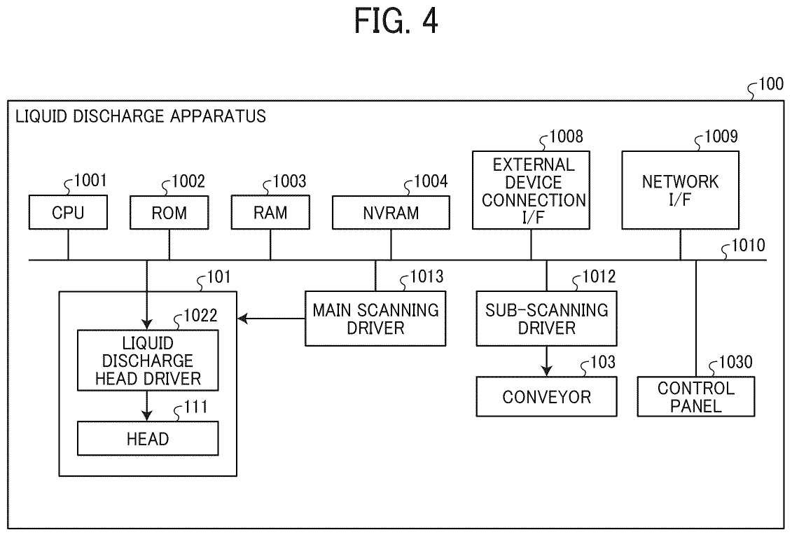

Hardware configurations of the liquid discharge apparatus 100 and the information processing apparatus 400 will be described below. FIG. 4 is a block diagram illustrating a hardware configuration of the liquid discharge apparatus 100. The liquid discharge apparatus 100 includes a central processing unit (CPU) 1001, a read-only memory (ROM) 1002, a random-access memory (RAM) 1003, a nonvolatile random-access memory (NVRAM) 1004, an external device connection interface (I/F) 1008, a network I/F 1009, and a bus line 1010. The liquid discharge apparatus 100 further includes a sub-scanning driver 1012, a main scanning driver 1013, the liquid discharge unit 101, and a control panel 1030 in addition to the conveyor 103 described above. The liquid discharge unit 101 includes a liquid discharge head driver 1022 in addition to the head 111 described above.

The CPU 1001 controls the overall operations of the liquid discharge apparatus 100. The ROM 1002 stores programs such as an initial program loader (IPL) to boot the CPU 1001. The RAM 1003 is used as a work area for the CPU 1001. The NVRAM 1004 stores various kinds of data such as programs and retains various kinds of data even while the liquid discharge apparatus 100 is powered off. The external device connection I/F 1008 is connected to a personal computer (PC) via, for example, a universal serial bus (USB) cable to transmit and receive control signals and data of images to be printed to and from the PC.

The network I/F 1009 is an interface for data communication using a communication network such as the Internet. The bus line 1010 is, for example, an address bus or a data bus to electrically connect components such as the CPU 1001.

The conveyor 103 conveys the continuous sheet 110 in the sub-scanning direction along a conveyance path in the liquid discharge apparatus 100 as described above. The sub-scanning driver 1012 controls the movement of the continuous sheet 110 in the sub-scanning direction by the conveyor 103. The main scanning driver 1013 controls the movement of the liquid discharge unit 101 in the main scanning direction.

The head 111 of the liquid discharge unit 101 has multiple nozzles to discharge liquid such as ink. The head 111 is mounted on the liquid discharge unit 101 such that a discharge face (nozzle face on which the multiple nozzles are arrayed) faces the continuous sheet 110. The head 111 discharges liquid onto the continuous sheet 110 intermittently conveyed in the sub-scanning direction while moving in the main scanning direction and applies the liquid to a predetermined position of the continuous sheet 110 to form an image (i.e., image formation). The liquid discharge head driver 1022 is a driver that controls the driving of the head 111.

A pressure generator used in the liquid discharge head is not limited to a piezoelectric actuator (which may use a laminated-type piezoelectric element). For example, a thermal actuator using a thermoelectric transducer such as a thermal resistor, and an electrostatic actuator including a diaphragm and opposed electrodes can be used.

In the present specification, the terms “image formation,” “recording,” “printing,” “image printing,” and “fabricating” used herein may be used synonymously with each other.

The control panel 1030 includes a touch panel and an alarm lamp. The touch panel displays, for example, a current setting value and a selection screen, and receives an input from a user.

The liquid discharge head driver 1022 may not be mounted on the liquid discharge unit 101 and may be connected to the bus line 1010 outside the liquid discharge unit 101. Each of the main scanning driver 1013, the sub-scanning driver 1012, and the liquid discharge head driver 1022 may be a function implemented by a command from the CPU 1001 according to a program.

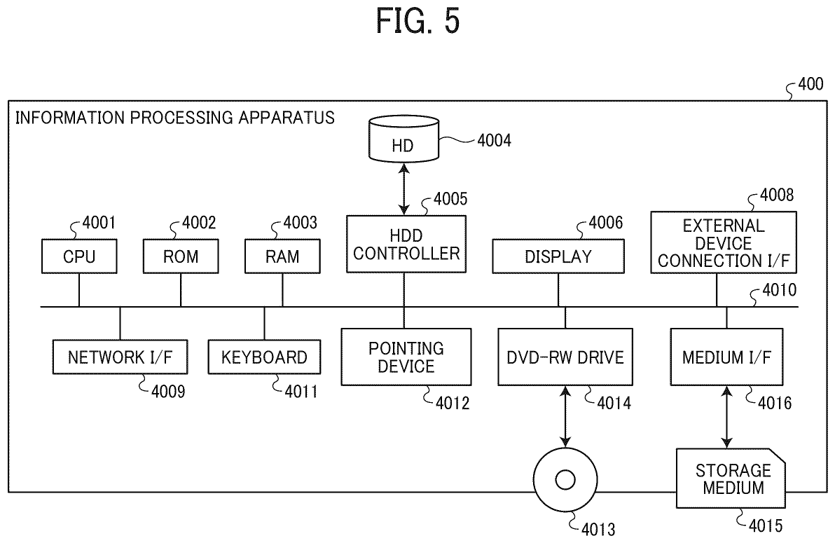

FIG. 5 is a block diagram illustrating a hardware configuration of the information processing apparatus 400. The information processing apparatus 400 is implemented by a computer and includes a CPU 4001, a ROM 4002, a RAM 4003, a hard disk (HD) 4004, a hard disk drive (HDD) controller 4005, a display 4006, an external device connection I/F 4008, a network I/F 4009, a bus line 4010, a keyboard 4011, a pointing device 4012, a digital versatile disc rewritable (DVD-RW) drive 4014, and a medium I/F 4016.

The CPU 4001 controls the overall operations of the information processing apparatus 400. The ROM 4002 stores programs such as an IPL to boot the CPU 4001. The RAM 4003 is used as a work area for the CPU 4001. The HD 4004 records various kinds of data such as programs. The HDD controller 4005 controls the reading and writing of various kinds of data from and to the HD 4004 under the control of the CPU 4001. The display 4006 is a kind of display unit using, for example, a liquid crystal or an organic electro luminescence (EL) that displays various kinds of information such as a cursor, a menu, a window, characters, or an image.

The external device connection I/F 4008 is an interface for connecting to various external devices. Examples of the external device include, but are not limited to, the liquid discharge apparatus 100 and a USB memory.

The network I/F 4009 is an interface for data communication using a communication network. The bus line 4010 is, for example, an address bus or a data bus to electrically connect the components illustrated in FIG. 5, such as the CPU 4001.

The keyboard 4011 is a kind of input device including multiple keys for a user to input, for example, characters, numerals, or various instructions. The pointing device 4012 is a kind of input device for, for example, selecting and executing various instructions, selecting a processing target, and moving a cursor. For example, a mouse, a touch pad, a trackball, a joystick, or a pen tablet is used as the pointing device 4012. The display 4006 and the pointing device 4012 may be implemented by a touch panel display to integrate the functions thereof.

The DVD-RW drive 4014 controls the reading and writing of various types of data from and to a DVD-RW 4013 as a removable storage medium. The removable storage medium is not limited to the DVD-RW 4013 and, for example, may be a DVD-recordable (DVD-R). The medium I/F 4016 controls the reading and writing (storing) of data from and to a storage medium 4015 such as a flash memory.

When the information processing apparatus 400 is installed in any one of the multiple liquid discharge apparatuses 100 (i.e., the liquid discharge apparatus 100 serving as a master unit), hardware may be shared by the master unit and the information processing apparatus 400. For example, the CPU 1001 and the CPU 4001, the ROM 1002 and the ROM 4002, and the RAM 1003 and the RAM 4003 each can be combined into the same hardware.

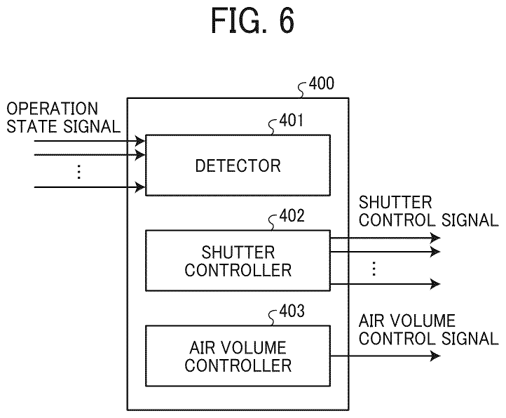

Control by the information processing apparatus 400 in the liquid discharge system 1 will be described below. FIG. 6 is a block diagram illustrating a functional configuration of the information processing apparatus 400. The information processing apparatus 400 includes a detector 401, a shutter controller 402, and an air volume controller 403.

The detector 401 receives operation state signals indicating operation states of the multiple liquid discharge apparatuses 100 from the liquid discharge apparatuses 100 to detect the operation state of each liquid discharge apparatus 100. The detector 401 may be a voltage sensor that measures voltages of the operation state signals to detect the operation state. For example, the operation state used herein indicates a state of the liquid discharge apparatus 100 such as power on, power off, printing (when liquid is discharged), or standby (when liquid is not discharged).

The shutter controller 402 transmits shutter control signals to the multiple shutters 300 to adjust the opening sizes of the shutters 300. The shutter 300 changes, for example, the area of the opening in response to the received shutter control signal to change the opening size. The air volume controller 403 transmits an air volume control signal to the exhaust device 200 to adjust an exhaust air volume of the exhaust device 200.

The shutter control signal and the air volume control signal are generated so as to be interlocked with each other. For example, when the shutter control signal indicates that the opening size of the shutter 300 is to be widened (increased), an air volume control signal indicating that the exhaust air volume of the exhaust device 200 is to be increased is generated. For example, when the shutter control signal indicates that the opening size of the shutter 300 is to be narrowed (decreased), an air volume control signal indicating that the exhaust air volume of the exhaust device 200 is to be decreased is generated.

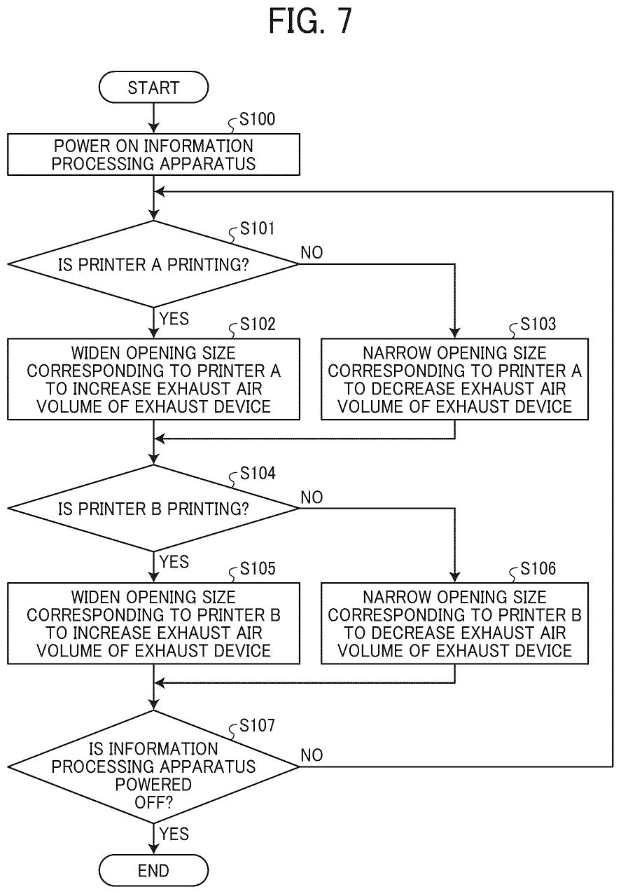

FIG. 7 is a flowchart of a control procedure in the liquid discharge system 1. Two liquid discharge apparatuses 100 (printer A and printer B) connected to the exhaust device 200 are described in the flowchart of FIG. 7, but three or more liquid discharge apparatuses 100 may be connected to the exhaust device 200.

In step S100, the information processing apparatus 400 is powered on. In step S101, the detector 401 detects the operation state of the printer A and determines whether the printer A is in printing. When the printer A is in printing (Yes in step S101), the shutter controller 402 transmits a shutter control signal for widening (increasing) the opening size to the shutter 300 corresponding to the printer A. The air volume controller 403 transmits an air volume control signal for increasing the exhaust air volume to the exhaust device 200. As a result, in step S102, the opening size corresponding to the printer A is widened, and the exhaust air volume of the exhaust device 200 is increased.

On the other hand, when the printer A is not in printing (No in step S101), the shutter controller 402 transmits a shutter control signal for narrowing (decreasing) the opening size to the shutter 300 corresponding to the printer A. The air volume controller 403 transmits an air volume control signal for decreasing the exhaust air volume to the exhaust device 200. As a result, in step S103, the opening size corresponding to the printer A is narrowed, and the exhaust air volume of the exhaust device 200 is decreased.

The same process as the process for the printer A described above is also executed for the printer B. The procedure of steps S104 to S106 for the printer B is the same as steps S101 to S103 for the printer A, and thus the description thereof will be omitted. In addition, when three or more liquid discharge apparatuses 100 are used, the process similar to the process for the printer A described above is executed for the third and subsequent liquid discharge apparatuses 100.

When the information processing apparatus 400 is powered off (Yes in step S107), the control process in the liquid discharge system 1 is ended, and when the power of the information processing apparatus 400 is on (No in step S107), the process in steps S101 to S106 is repeated. In the repeated process, the shutter controller 402 and the air volume controller 403 transmit the respective control signals only to the shutter 300 corresponding to the liquid discharge apparatus 100 in which the operation state has changed and the exhaust device 200, respectively.

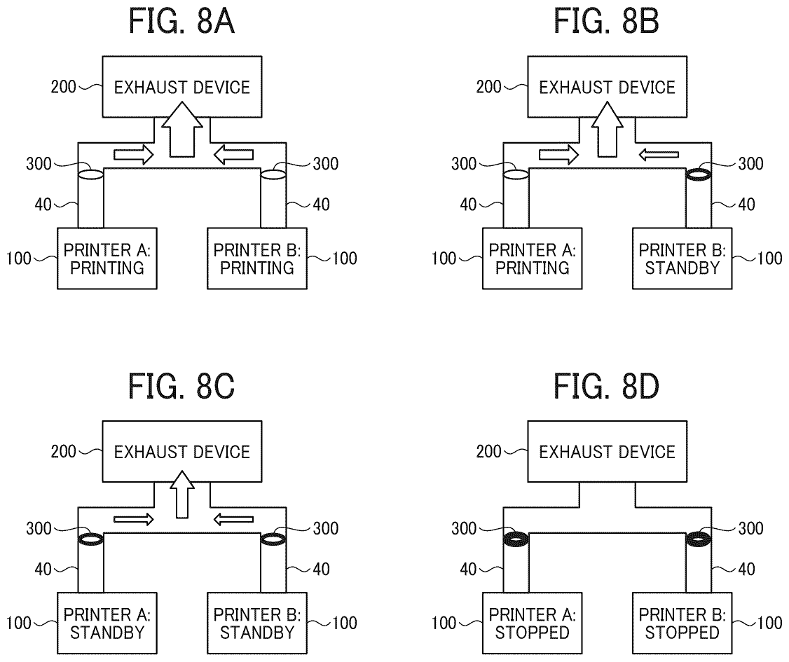

FIGS. 8A to 8D are diagrams each illustrating control of the shutter 300 and the exhaust device 200. Two liquid discharge apparatuses 100 (printer A and printer B) connected to the exhaust device 200 are illustrated in each of FIGS. 8A to 8D.

FIG. 8A illustrates the printer A and the printer B both in printing (i.e., in a printing mode). Each shutter 300 is controlled to widen the opening size, and the exhaust device 200 is controlled to increase the exhaust air volume.

FIG. 8B illustrates the printer A in printing and the printer B on standby (i.e., in a standby mode). The shutter 300 corresponding to the printer A is controlled to widen the opening size, the shutter 300 corresponding to the printer B is controlled to narrow the opening size, and the exhaust device 200 is controlled so that the exhaust air volume is smaller than that in FIG. 8A.

FIG. 8C illustrates the printer A and the printer B both on standby. Each shutter 300 is controlled to narrow the opening size, and the exhaust device 200 is controlled so that the exhaust air volume is smaller than that in FIG. 8B.

FIG. 8D illustrates the printer A and the printer B both stopped (i.e., in a power-off state). Each shutter 300 is controlled to minimize the opening size (decrease the opening size smaller than in the standby mode or close the shutter 300), and the exhaust device 200 is controlled so that the exhaust air volume is smaller than that in FIG. 8C (or the exhaust is stopped). For such control, the detector 401 detects the stopped state (i.e., the power-off state) of the liquid discharge apparatus 100, and the shutter controller 402 transmits the shutter control signal to minimize the opening size of the shutter 300 (decrease the opening size smaller than in the standby mode or close the shutter 300) corresponding to the stopped liquid discharge apparatus 100. When all the liquid discharge apparatuses 100 are stopped, the air volume controller 403 can transmit an air volume control signal to minimize the exhaust air volume (or stop the exhaust) to the exhaust device 200.

As described above, the opening size of the shutter 300 and the exhaust air volume of the exhaust device 200 are controlled based on the operation state of each of the multiple liquid discharge apparatuses 100 connected to the exhaust device 200 shared by all the liquid discharge apparatuses 100. As a result, the power consumption for the exhaust can be reduced.

### Second Embodiment

In a second embodiment of the present disclosure, the air volume in each exhaust duct 40 is detected, and a failure (i.e., a malfunctioning) of the shutter 300 can be detected based on the detected air volume and the state (e.g., the opening size) of the shutter 300 in each exhaust duct 40. In the following description of the second embodiment, descriptions of elements overlapped with those in the first embodiment are omitted, and differences from the first embodiment are described.

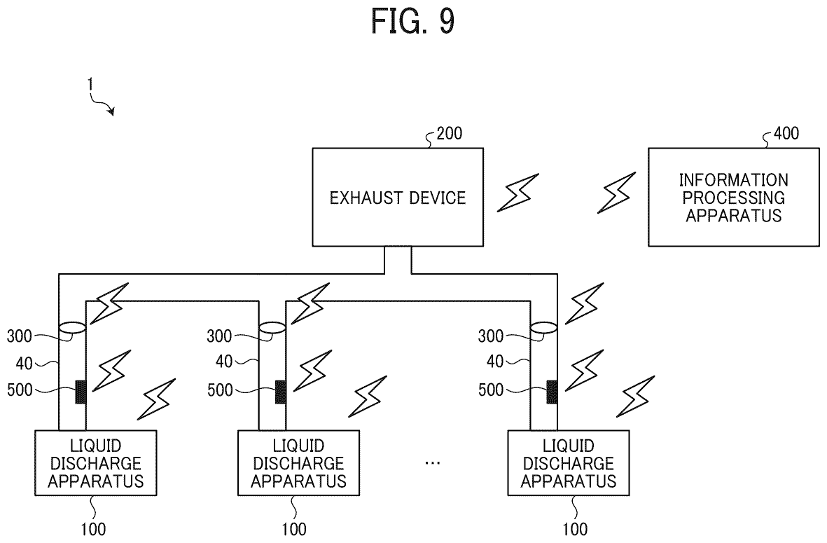

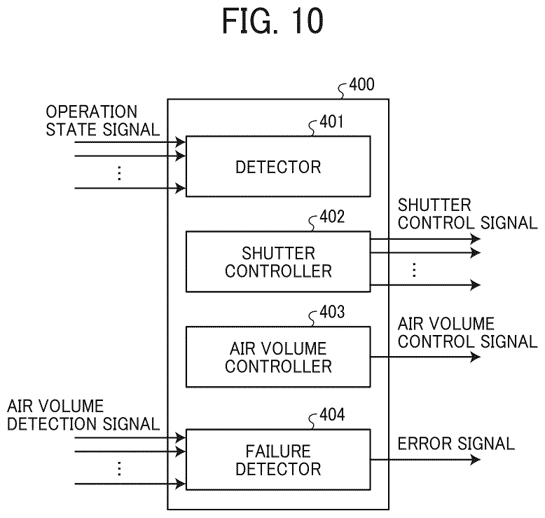

FIG. 9 is a diagram illustrating a configuration of a liquid discharge system 1 according to the second embodiment. FIG. 10 is a block diagram illustrating a functional configuration of an information processing apparatus 400. The difference from the first embodiment is that a sensor 500 to detect the air volume is disposed inside each exhaust duct 40, and that the information processing apparatus 400 includes a failure detector 404. The sensor 500 and the information processing apparatus 400 are connected to each other via a wired or wireless connection to communicate with each other.

The sensor 500 is, for example, an air volume sensor or a wind pressure sensor. The sensor 500 detects, for example, the air volume of gas flowing through the exhaust duct 40 and outputs an air volume detection signal. The failure detector 404 receives the air volume detection signal of each exhaust duct 40 and detects a failure of the shutter 300 in the exhaust duct 40. The failure detector 404 determines whether the shutter 300 is in failure (malfunctioning) based on the air volume of the exhaust duct 40 indicated by the air volume detection signal received from the sensor 500 and the opening size indicated by the shutter control signal transmitted to the shutter 300. Thus, the failure detector 404 detects a failure of the shutter 300.

When the failure detector 404 determines that the shutter 300 is in failure, the failure detector 404 transmits an error signal to the liquid discharge apparatus 100 connected to the corresponding exhaust duct 40. For example, the liquid discharge apparatus 100 that has received the error signal stops printing or turns off the power supply thereof.

The failure detector 404 determines that the shutter 300 is in failure, for example, when the opening size is larger than a first size T1 and the air volume is smaller than a first air volume U1, or when the opening size is smaller than a second size T2 and the air volume is larger than a second air volume U2. In the former case, the air volume is smaller than the first air volume U1 even though the shutter control signal indicating the opening size larger than the first size T1 is transmitted to increase the air volume, and thus the failure detector 404 determines that the failure has occurred. In the latter case, the air volume is larger than the second air volume U2 even though the shutter control signal indicating the opening size smaller than the second size T2 is transmitted to decrease the air volume, and thus the failure detector 404 determines that the failure has occurred. The values of the first size T1, the first air volume U1, the second size T2, and the second air volume U2 are preset, for example, in a manufacturing plant based on experiments. The first size T1 and the second size T2 may be set to the same value for each shutter 300 or each exhaust duct 40, or may be set to different values for each shutter 300 or each exhaust duct 40. The first air volume U1 and the second air volume U2 may be set to the same value for each shutter 300 or each exhaust duct 40, or may be set to different values for each shutter 300 or each exhaust duct 40. These values may be dynamically changed according to the operation state of the liquid discharge system 1. The first size T1 and the second size T2 may be the same value, and the first air volume U1 and the second air volume U2 may be the same value.

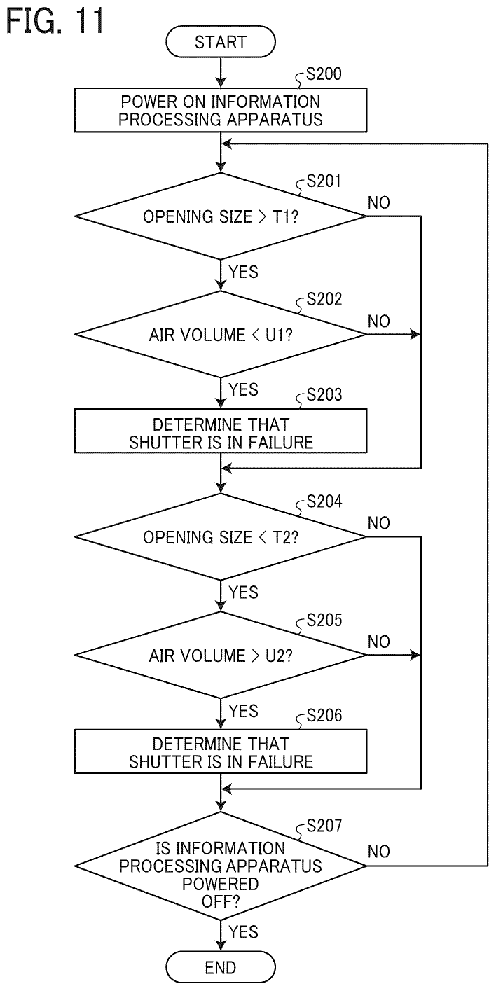

FIG. 11 is a flowchart of a procedure of failure detection by the failure detector 404. Although the procedure for the shutter 300 disposed in one exhaust duct 40 is described below, the failure detection is performed in the same procedure for the shutters 300 in the other exhaust ducts 40.

In step S200, the information processing apparatus 400 is powered on. In step S201, the failure detector 404 determines whether the opening size indicated by the shutter control signal transmitted to the shutter 300 is larger than the first size T1.

When the opening size is larger than the first size T1 (Yes in step S201), in step S202, the failure detector 404 determines whether the air volume of the exhaust duct 40 is smaller than the first air volume U1. When the air volume is smaller than the first air volume U1 (Yes in step S202), in step S203, the failure detector 404 determines that the shutter 300 is in failure. When the air volume is not smaller than the first air volume U1 (No in step S202), the process proceeds to step S204. When the opening size is not larger than the first size T1 (No in step S201), the process proceeds to step S204.

In step S204, the failure detector 404 determines whether the opening size indicated by the shutter control signal transmitted to the shutter 300 is smaller than the second size T2.

When the opening size is smaller than the second size T2 (Yes in step S204), in step S205, the failure detector 404 determines whether the air volume of the exhaust duct 40 is larger than the second air volume U2. When the air volume is larger than the second air volume U2 (Yes in step S205), in step S206, the failure detector 404 determines that the shutter 300 is in failure, and the process proceeds to step S207.

When the air volume is not larger than the second air volume U2 (No in step S205), the process proceeds to step S207. When the opening size is not smaller than the second size T2 (No in step S204), the process proceeds to step S207.

When the information processing apparatus 400 is powered off (Yes in step S207), the process of the failure detection is ended, and when the power of the information processing apparatus 400 is on (No in step S207), the process in steps S201 to S206 is repeated.

As described above, a failure of the shutter 300 can be detected based on the air volume of the exhaust duct 40 and the opening size indicated by the shutter control signal transmitted to the shutter 300. When a failure is detected, the failure detector 404 transmits an error signal to the corresponding liquid discharge apparatus 100, for example, to stop printing or power off the liquid discharge apparatus 100, and thus insufficient exhaust or excessive exhaust can be avoided.

### Third Embodiment

In a third embodiment of the present disclosure, the temperature and humidity inside each liquid discharge apparatus 100 are detected, and the opening size of the shutter 300 and the exhaust air volume of the exhaust device 200 can be controlled in multiple levels based on the detected temperature and humidity. In the following description of the third embodiment, descriptions of elements overlapped with those in the first embodiment are omitted, and differences from the first embodiment are described.

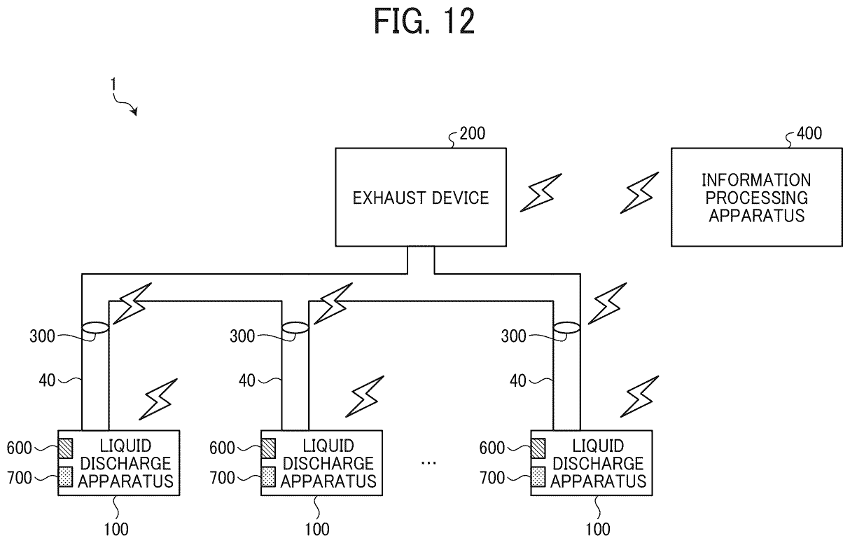

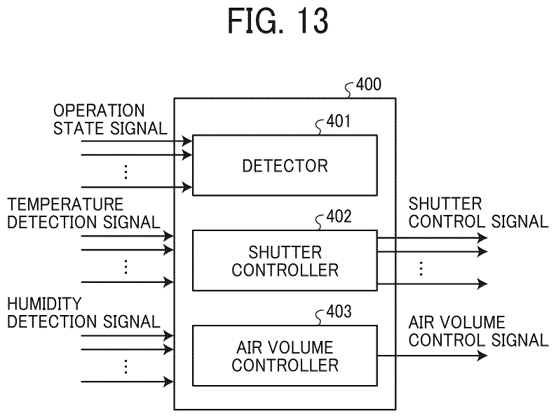

FIG. 12 is a diagram illustrating a configuration of a liquid discharge system 1 according to the third embodiment. FIG. 13 is a block diagram illustrating a functional configuration of an information processing apparatus 400. The difference from the first embodiment is that each liquid discharge apparatus 100 includes a temperature sensor 600 and a humidity sensor 700, and that the information processing apparatus 400 receives a temperature detection signal and a humidity detection signal, and the shutter controller 402 and the air volume controller 403 perform control using these signals. Accordingly, the opening size of the shutter 300 and the exhaust air volume of the exhaust device 200 are changed according to the temperature and humidity conditions inside the liquid discharge apparatus 100 in addition to the operation state of the liquid discharge apparatus 100. Thus, the exhaust air volume can be weakened while maintaining the exhaust air volume for the liquid discharge apparatus 100. Further, the power consumption of the entire liquid discharge system 1 can be reduced by weakening the exhaust air volume of the exhaust device 200.

The temperature sensor 600 detects the temperature inside the liquid discharge apparatus 100 and transmits a temperature detection signal indicating the detected temperature to the information processing apparatus 400. The humidity sensor 700 detects the humidity inside the liquid discharge apparatus 100 and transmits a humidity detection signal indicating the detected humidity to the information processing apparatus 400.

The shutter controller 402 adjusts the opening size of the shutter 300 to one of three or more levels based on the temperature detection signal and the humidity detection signal. The air volume controller 403 adjusts the exhaust air volume of the exhaust device 200 to one of three or more levels based on the temperature detection signal and the humidity detection signal.

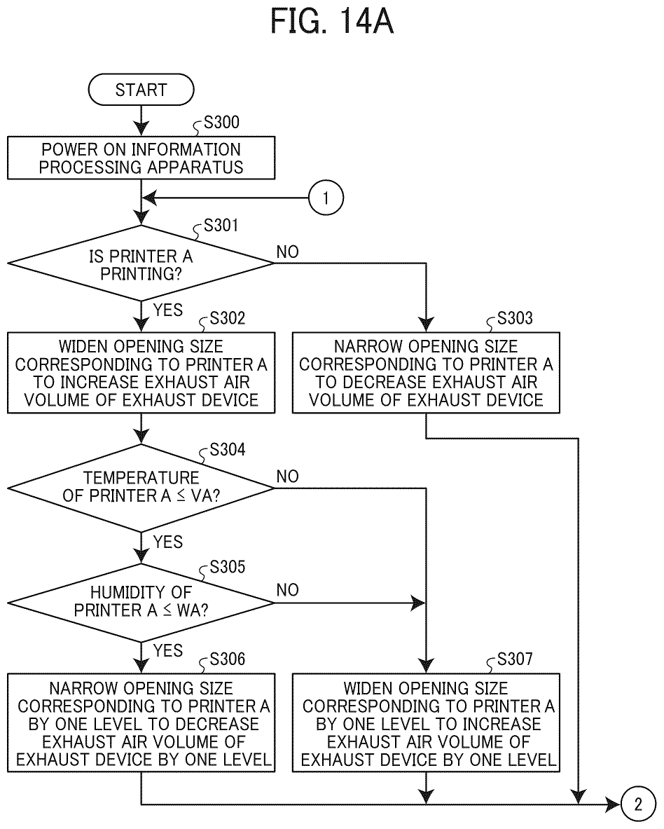

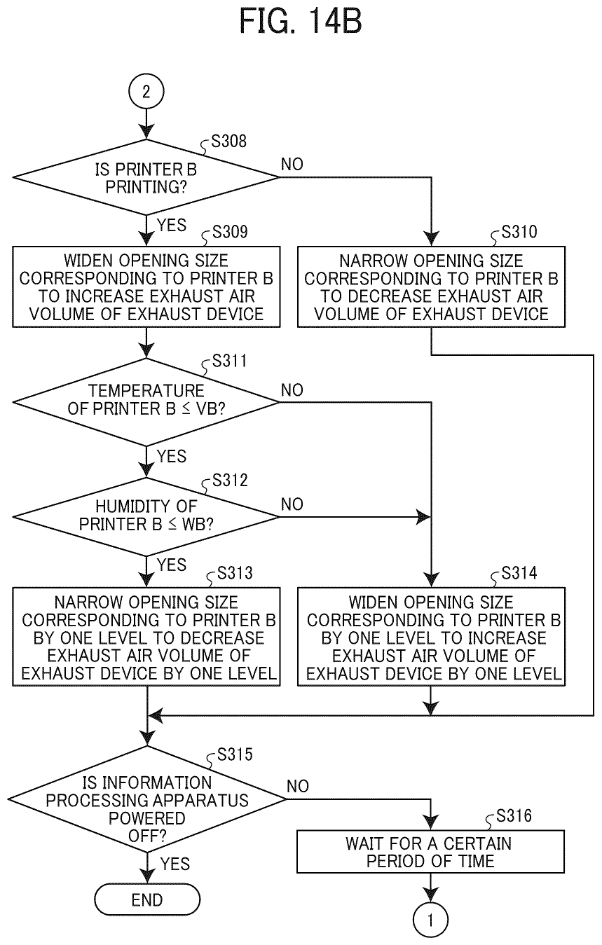

FIGS. 14A and 14B are a flowchart of a control procedure in the liquid discharge system 1. Two liquid discharge apparatuses 100 (printer A and printer B) connected to the exhaust device 200 are described in the flowchart of FIGS. 14A and 14B, but three or more liquid discharge apparatuses 100 may be connected to the exhaust device 200.

In step S300, the information processing apparatus 400 is powered on. In step S301, the detector 401 detects the operation state of the printer A and determines whether the printer A is in printing. When the printer A is in printing (Yes in step S301), the shutter controller 402 transmits a shutter control signal for widening the opening size to the shutter 300 corresponding to the printer A. The air volume controller 403 transmits an air volume control signal for increasing the exhaust air volume to the exhaust device 200. As a result, in step S302, the opening size corresponding to the printer A is widened, and the exhaust air volume of the exhaust device 200 is increased.

On the other hand, when the printer A is not in printing (No in step S301), the shutter controller 402 transmits a shutter control signal for narrowing the opening size to the shutter 300 corresponding to the printer A. The air volume controller 403 transmits an air volume control signal for decreasing the exhaust air volume to the exhaust device 200. As a result, in step S303, the opening size corresponding to the printer A is narrowed, and the exhaust air volume of the exhaust device 200 is decreased. After step S303, the process proceeds to step S308.

After step S302, when the temperature inside the printer A is equal to or lower than a first threshold VA (Yes in step S304) and the moisture inside the printer A is equal to or lower than a second threshold WA (Yes in step S305), the shutter controller 402 transmits a shutter control signal for narrowing the opening size to one lower level to the shutter 300 corresponding to the printer A. The air volume controller 403 transmits an air volume control signal for decreasing the exhaust air volume to one lower level to the exhaust device 200. As a result, in step S306, the opening size corresponding to the printer A is narrowed by one level, and the exhaust air volume of the exhaust device 200 is decreased by one level. When the opening size is already at the minimum level, the shutter controller 402 does not transmit a shutter control signal, or the shutter 300 ignores the received shutter control signal. Similarly, when the exhaust air volume is already at the minimum level, the air volume controller 403 does not transmit an air volume control signal, or the exhaust device 200 ignores the received air volume control signal.

On the other hand, when the temperature inside the printer A is equal to or lower than the first threshold VA (Yes in step S304) and the moisture inside the printer A is higher than the second threshold WA (No in step S305), or when the temperature inside the printer A is higher than the first threshold VA (No in step S304), the shutter controller 402 transmits a shutter control signal for widening the opening size to one higher level to the shutter 300 corresponding to the printer A. The air volume controller 403 transmits an air volume control signal for increasing the exhaust air volume to one higher level to the exhaust device 200. As a result, in step S307, the opening size corresponding to the printer A is widened by one level, and the exhaust air volume of the exhaust device 200 is increased by one level. When the opening size is already at the maximum level, the shutter controller 402 does not transmit a shutter control signal, or the shutter 300 ignores the received shutter control signal. Similarly, when the exhaust air volume is already at the maximum level, the air volume controller 403 does not transmit an air volume control signal, or the exhaust device 200 ignores the received air volume control signal.

The process similar to the process for the printer A described above is executed for the printer B. The procedure of steps S308 to S314 for the printer B is similar to steps S301 to S307 for the printer A, and thus the description thereof will be omitted. When the information processing apparatus 400 is powered off (Yes in step S315), the control process in the liquid discharge system 1 is ended. When the power of the information processing apparatus 400 is on (No in step S315), in step S316, a certain period of time has elapsed, and then the process in steps S301 to S314 is repeated. In steps S302, S303, S306, S307, S309, S310, S313, and S314 in the repeated process, the shutter controller 402 and the air volume controller 403 transmit the respective control signals only to the shutter 300 corresponding to the liquid discharge apparatus 100 in which the operation state has changed and the exhaust device 200, respectively.

The values of the first threshold VA and the second threshold WA for the printer A, and a first threshold VB and a second threshold WB for the printer B are preset, for example, in a manufacturing plant based on experiments. When the temperature inside the liquid discharge apparatus 100 rises, the temperature of a component of the liquid discharge apparatus 100 may exceed the rated temperature, and a failure of the component may occur. When the humidity inside the liquid discharge apparatus 100 rises, for example, a short circuit of the electrical components due to condensation may occur, or the continuous sheet 110 may be stained by condensation. To prevent such a situation, for example, the values of the first thresholds VA and VB and the second thresholds WA and WB can be preset by experiments. For example, the first threshold VA for the printer A and the first threshold VB for the printer B may be set to the same value for each liquid discharge apparatus 100, or may be set to different values for each liquid discharge apparatus 100. For example, the second threshold WA for the printer A and the second threshold WB for the printer B may be set to the same value for each liquid discharge apparatus 100, or may be set to different values for each liquid discharge apparatus 100. These values may be dynamically changed according to the operation state of the liquid discharge system 1.

As described above, the temperature and the humidity are detected and the exhaust air volume is adjusted in the multiple levels to prevent the temperature and the humidity inside the liquid discharge apparatus 100 from excessively rising.

### Fourth Embodiment

In a fourth embodiment of the present disclosure, each of multiple units included in one liquid discharge apparatus 100 includes the exhaust duct 40 and the shutter 300, and the opening size of the shutter 300 and the exhaust air volume of the exhaust device 200 are adjusted according to the operation state of each unit. In the following description of the fourth embodiment, descriptions of elements overlapped with those in the first embodiment are omitted, and differences from the first embodiment are described.

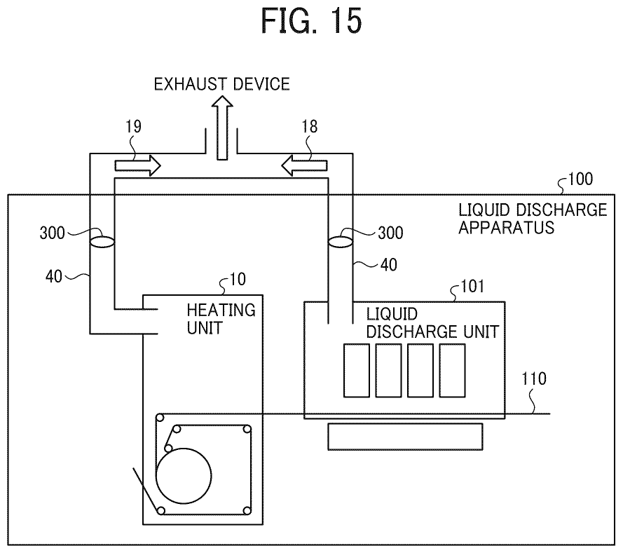

FIG. 15 is a schematic view of a liquid discharge apparatus 100, illustrating a configuration relating to an exhaust process. The multiple units of the liquid discharge apparatus 100 are the liquid discharge unit 101 and the heating unit 10. The difference from the first embodiment is that each shutter 300 is disposed inside the liquid discharge apparatus 100 (e.g., in a portion of exhaust duct 40 connected to the heating unit 10 or the liquid discharge unit 101). The liquid discharge apparatus 100 controls the exhaust air volume from each of the heating unit 10 and the liquid discharge unit 101.

As illustrated in FIG. 15, the liquid discharge unit 101 discharges liquid onto the continuous sheet 110 to form an image, and the heating unit 10 heats and dries the continuous sheet 110. The ink mist 18 generated during image formation in the liquid discharge unit 101 and the vapor 19 generated in the heating unit 10 are exhausted by the external exhaust device 200 via the respective exhaust ducts 40 and the shutters 300. The liquid discharge unit 101 is an image forming unit. The shutters 300 are disposed in the exhaust ducts 40 connected to the liquid discharge unit 101 and the heating unit 10 of the liquid discharge apparatus 100. For example, the opening size of the shutter 300 is adjusted to be small in the exhaust duct 40 connected to the liquid discharge unit 101 when image formation is not performed. Accordingly, the liquid discharge apparatus 100 decreases the total exhaust air volume from the liquid discharge apparatus 100 while maintaining the exhaust air volume from the heating unit 10. The air in the heating unit 10 is exhausted to keep a standby temperature of the heating unit 10. As a result, the liquid discharge apparatus 100 can weaken the exhaust air volume of the exhaust device 200 and reduce the power consumption of the entire system.

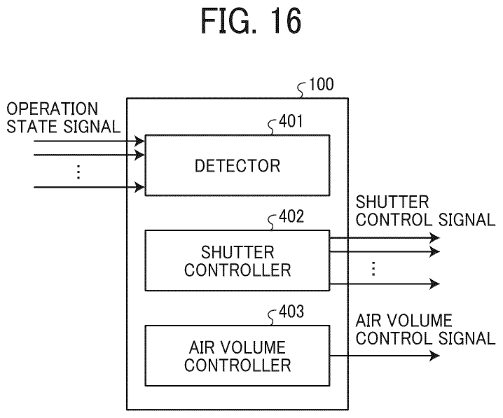

FIG. 16 is a block diagram illustrating a functional configuration of the liquid discharge apparatus 100. The liquid discharge apparatus 100 includes the detector 401, the shutter controller 402, and the air volume controller 403 as functional units.

The difference from FIG. 6 described in the first embodiment is that each functional unit is disposed in the liquid discharge apparatus 100, and the operation state signals input to the detector 401 are signals indicating the operation states of the multiple units of the liquid discharge apparatus 100.

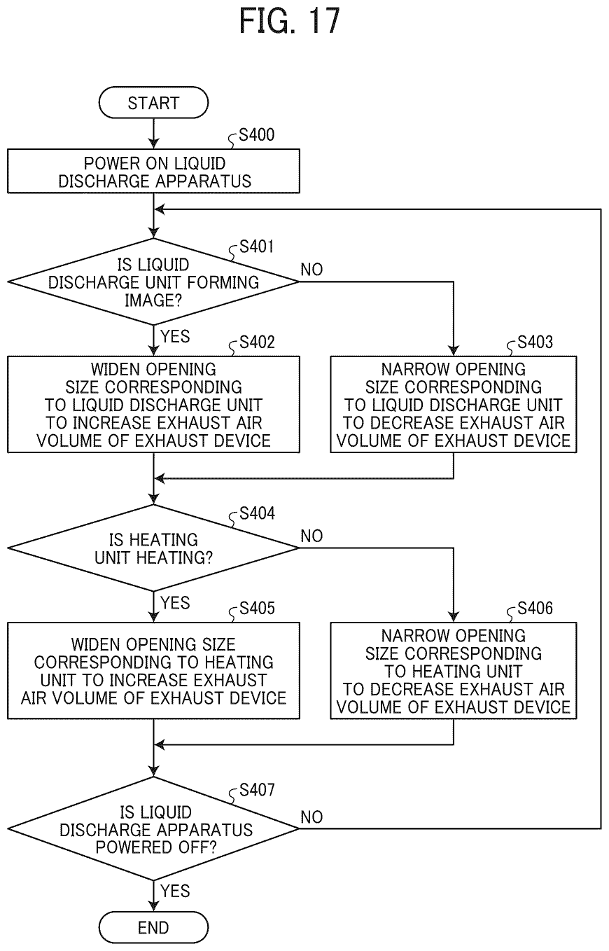

FIG. 17 is a flowchart of a procedure of exhaust control in the liquid discharge apparatus of 100. Similarly to FIG. 15, the multiple units are the liquid discharge unit 101 and the heating unit 10.

In step S400, the liquid discharge apparatus 100 is powered on. In step S401, the detector 401 detects the operation state of the liquid discharge unit 101 and determines whether the liquid discharge unit 101 is forming an image. When the liquid discharge unit 101 is forming an image (Yes in step S401), the shutter controller 402 transmits a shutter control signal for widening the opening size to the shutter 300 corresponding to the liquid discharge unit 101. The air volume controller 403 transmits an air volume control signal for increasing the exhaust air volume to the exhaust device 200. As a result, in step S402, the opening size corresponding to the liquid discharge unit 101 is widened, and the exhaust air volume of the exhaust device 200 is increased.

On the other hand, when the liquid discharge unit 101 is not forming an image (No in step S401), the shutter controller 402 transmits a shutter control signal for narrowing the opening size to the shutter 300 corresponding to the liquid discharge unit 101. The air volume controller 403 transmits an air volume control signal for decreasing the exhaust air volume to the exhaust device 200. As a result, in step S403, the opening size corresponding to the liquid discharge unit 101 is narrowed, and the exhaust air volume of the exhaust device 200 is decreased.

In step S404, the detector 401 detects the operation state of the heating unit 10 and determines whether the heating unit 10 is heating the continuous sheet 110. When the heating unit 10 is heating (Yes in step S404), the shutter controller 402 transmits a shutter control signal for widening the opening size to the shutter 300 corresponding to the heating unit 10. The air volume controller 403 transmits an air volume control signal for increasing the exhaust air volume to the exhaust device 200. As a result, in step S405, the opening size corresponding to the heating unit 10 widened, and the exhaust air volume of the exhaust device 200 is increased.

On the other hand, when the heating unit 10 is not heating (No in step S404), the shutter controller 402 transmits a shutter control signal for narrowing the opening size to the shutter 300 corresponding to the heating unit 10. The air volume controller 403 transmits an air volume control signal for decreasing the exhaust air volume to the exhaust device 200. As a result, in step S406, the opening size corresponding to the heating unit 10 is narrowed, and the exhaust air volume of the exhaust device 200 is decreased.

When the liquid discharge apparatus 100 is powered off (Yes in step S407), the process of the exhaust control is ended, and when the power of the liquid discharge apparatus 100 is on (No in step S407), the process in steps S401 to S406 is repeated. In the repeated process, the shutter controller 402 and the air volume controller 403 transmit the respective control signals only to the shutter 300 corresponding to the unit in which the operation state has changed and the exhaust device 200, respectively.

In the above description, the operation state of the heating unit 10 is detected by the operation state signal. Alternatively, a temperature sensor may be disposed in the heating unit 10, and the operation state of the heating unit 10 may be detected by a temperature detection signal from the temperature sensor. In this case, the detector 401 determines whether the temperature indicated by the temperature detection signal is higher than a predetermined threshold. The shutter controller 402 and the air volume controller 403 execute step S405 described above when the temperature is higher than the predetermined threshold and execute step S406 described above when the temperature is equal to or lower than the predetermined threshold to control the exhaust air volume. The threshold is preset, for example, in a manufacturing plant based on experiments. The number of the multiple units is not limited to two and may be three or more.

As described above, the opening size of the shutter 300 and the exhaust air volume of the exhaust device 200 are controlled based on the operation state of each of the multiple units included in the liquid discharge apparatus 100. As a result, the power consumption for the exhaust can be reduced.

Although some embodiments of the present disclosure have been described above, the above-described embodiments are presented as examples and are not intended to limit the scope of the present disclosure. For example, in the fourth embodiment, the detector 401, the shutter controller 402, and the air volume controller 403 may be disposed in the information processing apparatus 400, and the information processing apparatus 400 may control the shutter 300 of the liquid discharge apparatus 100 and the exhaust device 200. The above-described novel embodiments can be implemented in other various forms, and various omissions, replacements, and changes can be made without departing from the scope of the present disclosure. Such novel embodiments and variations thereof are included in the scope and gist of the present disclosure and are included in the scope of the appended claims and the equivalent scope thereof. Further, configurations in different embodiments and modifications may be combined as appropriate.

The programs executed on the information processing apparatus 400 or the liquid discharge apparatus 100 described above are stored, in an installable or executable file format, in a computer readable storage medium, such as a compact disc-read-only memory (CD-ROM), a flexible disk (FD), a compact disc-recordable (CD-R), and a digital versatile disc (DVD).

Alternatively, the programs executed on the information processing apparatus 400 or the liquid discharge apparatus 100 may be stored in a computer connected to a network such as the Internet and downloaded via the network. The programs executed on the information processing apparatus 400 or the liquid discharge apparatus 100 may be provided or distributed via a network such as the Internet. Further, the programs may be provided by being incorporated in advance in, for example, the ROM 1002.

The programs executed on the information processing apparatus 400 or the liquid discharge apparatus 100 has a modular configuration including the above-described units (e.g., the detector 401, the shutter controller 402, and the air volume controller 403). The CPU 1001 (i.e., a processor) serving as actual hardware reads the programs from the storage medium described above and executes the program so as to load these units described above on a main storage device to implement, for example, the detector 401, the shutter controller 402, and the air volume controller 403 on the main storage device.

Each function of the embodiments described above can be implemented by one processing circuit or multiple processing circuits. The term “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

In the present disclosure, the term “liquid discharge apparatus” includes a liquid discharge head or a liquid discharge unit and drives the liquid discharge head to discharge liquid. The term “liquid discharge apparatus” used herein includes, in addition to apparatuses to discharge liquid to a medium onto which liquid can adhere, apparatuses to discharge the liquid into gas (air) or a different liquid.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In another example, a cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading device only.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Further, the term “liquid” is not limited to a particular liquid and includes any liquid having a viscosity or a surface tension that can be discharged from the head. However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

Aspects of the present disclosure are, for example, as follows.

### Aspect 1

A liquid discharge system includes an exhaust device, multiple liquid discharge apparatuses, multiple exhaust ducts connecting the exhaust device and the multiple liquid discharge apparatuses, multiple shutters to adjust exhaust air volumes of the exhaust ducts, a detector to detect operation states of the multiple liquid discharge apparatuses, a shutter controller to control opening sizes of the multiple shutters, and an air volume controller to control an exhaust air volume of the exhaust device. The shutter controller controls the opening sizes based on the operation states detected by the detector. The air volume controller controls the exhaust air volume based on the operation states detected by the detector.

In other words, a liquid discharge system includes multiple liquid discharge apparatuses, a detector, an exhaust device, multiple exhaust ducts, multiple shutters, and circuitry. The multiple liquid discharge apparatuses discharge a liquid. The detector detects an operation state of each of the multiple liquid discharge apparatuses. The exhaust device exhausts air from each of the multiple liquid discharge apparatuses. The multiple exhaust ducts respectively connect the multiple liquid discharge apparatuses to the exhaust device. The multiple shutters respectively adjust an air volume of the air exhausted through the multiple exhaust ducts. The circuitry controls each of the multiple shutters to change an opening size of corresponding one of the multiple shutters based on the operation state detected by the detector and controls the exhaust device to change the air volume based on the operation state.

### Aspect 2

In the liquid discharge system according to Aspect 1, when the detector detects a liquid discharge apparatus that is not discharging liquid, the shutter controller reduces the opening size of the shutter corresponding to the liquid discharge apparatus, and the air volume controller reduces the exhaust air volume.

In other words, the circuitry controls the detector to detect whether each of the multiple liquid discharge apparatuses is in one of the operation state including in a printing mode to discharge the liquid or in a standby mode not discharging the liquid, controls at least one of the multiple shutters of the multiple liquid discharge apparatuses to decrease the opening size of each of the at least one of the multiple shutters when it is detected to be in the standby mode, and decreases the air volume of the exhaust device.

In addition, the operation state further includes a power-off state. The circuitry controls at least one of the multiple shutters of the multiple liquid discharge apparatuses to decrease the opening size of each of the at least one of the multiple shutters in the power-off state smaller than in the standby mode when it is detected to be in the power-off state and decreases the air volume of the exhaust device in the power-off state smaller than in the standby mode.

### Aspect 3

The liquid discharge system according to Aspect 1 or 2, further includes multiple sensors to detect an air volume of each of the multiple exhaust ducts and a failure detector to detect a failure of the multiple shutters. The failure detector detects the failure of the shutter based on the air volume detected by the sensor and a state of the shutter of the exhaust duct corresponding to the sensor.

In other words, the liquid discharge system according to Aspect 1 or 2, further includes multiple sensors to respectively detect the air volume of the multiple exhaust ducts. The circuitry detects a malfunctioning of a shutter of the multiple shutters based on the air volume detected by the multiple sensors and the opening size of each of the multiple shutters.

### Aspect 4

In the liquid discharge system according to Aspect 3, the failure detector determines that the shutter is in failure when the shutter controller transmits a control signal for increasing the opening size to be larger than a first size to the shutter and the air volume is smaller than a first air volume.

In other words, the circuitry controls the shutter to increase the opening size to be larger than a first size corresponding to a first air volume and determines that the shutter is malfunctioning when the air volume detected by the multiple sensors is smaller than the first air volume.

### Aspect 5

In the liquid discharge system according to Aspect 3, the failure detector determines that the shutter is in failure when the shutter controller transmits a control signal for decreasing the opening size to be smaller than a second size to the shutter and the air volume is larger than a second air volume.

In other words, the circuitry controls the shutter to decrease the opening size to be smaller than a second size corresponding to a second air volume and determines that the shutter is malfunctioning when the air volume detected by the multiple sensors is larger than the second air volume.

### Aspect 6

The liquid discharge system according to any one of Aspects 1 to 5, further includes multiple temperature sensors to detect temperatures of the multiple liquid discharge apparatuses and multiple humidity sensors to detect humidities of the multiple liquid discharge apparatuses. The shutter controller adjusts the opening size to any one of three or more levels based on the temperature detected by the temperature sensor and the humidity detected by the humidity sensor. The air volume controller adjusts the exhaust air volume to any one of three or more levels based on the temperature detected by the temperature sensor and the humidity detected by the humidity sensor.

In other words, the liquid discharge system according to any one of Aspects 1 to 5, further includes multiple temperature sensors to detect a temperature of each of the multiple liquid discharge apparatuses, respectively, and multiple humidity sensors to detect a humidity of each of the multiple liquid discharge apparatuses, respectively. The circuitry changes the opening size in three or more levels and changes the air volume in three or more levels based on the temperature detected by the multiple temperature sensors and the humidity detected by the multiple humidity sensors.

### Aspect 7

In the liquid discharge system according to Aspect 6, in the liquid discharge apparatus to which the exhaust duct is connected, when the detected temperature is equal to or lower than a first threshold and the detected humidity is equal to or lower than a second threshold, the shutter controller adjusts the opening size to one lower level, and the air volume controller adjusts the exhaust air volume to one lower level.

In other words, the circuitry decreases the opening size to lower level in the three or more levels and decreases the air volume to lower level in the three or more levels in response to the temperature equal to or lower than a first threshold and the humidity equal to or lower than a second threshold.

### Aspect 8

The liquid discharge system according to Aspect 6, in the liquid discharge apparatus to which the exhaust duct is connected, when the detected temperature is equal to or lower than a first threshold and the detected humidity is higher than a second threshold, the shutter controller adjusts the opening size to one higher level, and the air volume controller adjusts the exhaust air volume to one higher level.

In other words, the circuitry increases the opening size to higher level in the three or more levels and increases the air volume to higher level in the three or more levels in response to the temperature equal to or lower than a first threshold and the humidity higher than a second threshold.

### Aspect 9

The liquid discharge system according to Aspect 6, in the liquid discharge apparatus to which the exhaust duct is connected, when the detected temperature is higher than a first threshold, the shutter controller adjusts the opening size to one higher level, and the air volume controller adjusts the exhaust air volume to one higher level.

In other words, the circuitry increases the opening size to higher level in the three or more levels and increases the air volume to higher level in the three or more levels in response to the temperature higher than a first threshold.

### Aspect 10

A liquid discharge apparatus includes an image forming unit to discharge a liquid onto an object, a heating unit to heat the object onto which the liquid has been discharged, multiple exhaust ducts connecting an exhaust device, and the image forming unit and the heating unit, multiple shutters to adjust exhaust air volumes of the exhaust ducts, a detector to detect operation states of the image forming unit and the heating unit, a shutter controller to control opening sizes of the multiple shutters, and an air volume controller to control an exhaust air volume of the exhaust device. The shutter controller controls the opening sizes based on the operation states detected by the detector. The air volume controller controls the exhaust air volume based on the operation states detected by the detector.

In other words, a liquid discharge apparatus includes an image forming unit, a heating unit, a detector, multiple exhaust ducts, multiple shutters, and circuitry. The image forming unit discharges a liquid onto an object to forms an image on the object. The heating unit heats the object onto which the liquid has been discharged. The detector detects an operation state of each of the image forming unit and the heating unit. The exhaust device exhausts air from each of the image forming unit and the heating unit. The multiple exhaust ducts respectively connect the image forming unit and the heating unit to the exhaust device. The multiple shutters respectively adjust an air volume of the air exhausted through the multiple exhaust ducts. The circuitry controls each of the multiple shutters to change an opening size of corresponding one of the multiple shutters based on the operation state detected by the detector and controls the exhaust device to change the air volume based on the operation state.

### Aspect 11

A liquid discharge method is executed in a liquid discharge system including an exhaust device, multiple liquid discharge apparatuses, multiple exhaust ducts connecting the exhaust device and the multiple liquid discharge apparatuses, and multiple shutters to adjust exhaust air volumes of the exhaust ducts. The liquid discharge method includes a detection step to detect operation states of the multiple liquid discharge apparatuses, a shutter control step to control opening sizes of the multiple shutters, and an air volume control step to control an exhaust air volume of the exhaust device. The shutter control step controls the opening sizes based on the operation states detected by the detection step. The air volume control step controls the exhaust air volume based on the operation states detected by the detection step.

In other words, a liquid discharge method includes causing multiple liquid discharge apparatuses to discharge a liquid, detecting an operation state of each of the multiple liquid discharge apparatuses, exhausting air from each of the multiple liquid discharge apparatuses, causing multiple shutters to respectively adjust an air volume of the air exhausted from the multiple liquid discharge apparatuses, changing an opening size of each of the multiple shutters based on the operation state, and changing the air volume based on the operation state.

### Aspect 12

In a liquid discharge system including an exhaust device, multiple liquid discharge apparatuses, multiple exhaust ducts connecting the exhaust device and the multiple liquid discharge apparatuses, and multiple shutters to adjust exhaust air volumes of the exhaust ducts, a program causes a computer to function as a detection unit to detect operation states of the multiple liquid discharge apparatuses, a shutter control unit to control opening sizes of the multiple shutters, and an air volume control unit to control an exhaust air volume of the exhaust device. The shutter control unit controls the opening sizes based on the operation states detected by the detection unit. The air volume control unit controls the exhaust air volume based on the operation states detected by the detection unit.

According to one aspect of the present disclosure, when one exhaust device is connected to multiple liquid discharge apparatuses, power consumption for exhaust can be reduced according to the operation state of the connected liquid discharge apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid discharge system comprising:
multiple liquid discharge apparatuses to discharge a liquid;
a detector to detect an operation state of each of the multiple liquid discharge apparatuses;
an exhaust device to exhaust air from each of the multiple liquid discharge apparatuses;
multiple exhaust ducts respectively connecting the multiple liquid discharge apparatuses to the exhaust device;
multiple shutters to respectively adjust an air volume of the air exhausted through the multiple exhaust ducts; and
circuitry configured to:
control each of the multiple shutters to change an opening size of corresponding one of the multiple shutters based on the operation state detected by the detector; and
control the exhaust device to change the air volume based on the operation state.

2. The liquid discharge system according to claim 1,
wherein the circuitry is further configured to:
control the detector to detect whether each of the multiple liquid discharge apparatuses is in one of the operation state including:
in a printing mode to discharge the liquid; or
in a standby mode not discharging the liquid;
control at least one of the multiple shutters of the multiple liquid discharge apparatuses to decrease the opening size of each of the at least one of the multiple shutters when it is detected to be in the standby mode; and
decrease the air volume of the exhaust device.

3. The liquid discharge system according to claim 2,
wherein the operation state further includes a power-off state; and
the circuitry is further configured to:
control at least one of the multiple shutters of the multiple liquid discharge apparatuses to decrease the opening size of each of the at least one of the multiple shutters in the power-off state smaller than in the standby mode when it is detected to be in the power-off state; and
decrease the air volume of the exhaust device in the power-off state smaller than in the standby mode.

4. The liquid discharge system according to claim 1, further comprising multiple sensors to respectively detect the air volume of the multiple exhaust ducts,
wherein the circuitry is further configured to detect a malfunctioning of a shutter of the multiple shutters based on:
the air volume detected by the multiple sensors; and
the opening size of each of the multiple shutters.

5. The liquid discharge system according to claim 4,
wherein the circuitry is further configured to:
control the shutter to increase the opening size to be larger than a first size corresponding to a first air volume; and
determine that the shutter is malfunctioning when the air volume detected by the multiple sensors is smaller than the first air volume.

6. The liquid discharge system according to claim 4,
wherein the circuitry is further configured to:
control the shutter to decrease the opening size to be smaller than a second size corresponding to a second air volume; and
determine that the shutter is malfunctioning when the air volume detected by the multiple sensors is larger than the second air volume.

7. The liquid discharge system according to claim 1, further comprising:
multiple temperature sensors to detect a temperature of each of the multiple liquid discharge apparatuses, respectively; and
multiple humidity sensors to detect a humidity of each of the multiple liquid discharge apparatuses, respectively,
wherein the circuitry is further configured to:
change the opening size in three or more levels; and
change the air volume in three or more levels,
based on the temperature detected by the multiple temperature sensors and the humidity detected by the multiple humidity sensors.

8. The liquid discharge system according to claim 7,
wherein the circuitry is further configured to:
decrease the opening size to lower level in the three or more levels; and
decrease the air volume to lower level in the three or more levels,
in response to the temperature equal to or lower than a first threshold and the humidity equal to or lower than a second threshold.

9. The liquid discharge system according to claim 7,
wherein the circuitry is further configured to:
increase the opening size to higher level in the three or more levels; and
increase the air volume to higher level in the three or more levels,
in response to the temperature equal to or lower than a first threshold and the humidity higher than a second threshold.

10. The liquid discharge system according to claim 7,
wherein the circuitry is further configured to:
increase the opening size to higher level in the three or more levels; and
increase the air volume to higher level in the three or more levels,
in response to the temperature higher than a first threshold.

11. A liquid discharge apparatus comprising:
an image forming unit to discharge a liquid onto an object to forms an image on the object;
a heating unit to heat the object onto which the liquid has been discharged;
a detector to detect an operation state of each of the image forming unit and the heating unit;
an exhaust device to exhaust air from each of the image forming unit and the heating unit;
multiple exhaust ducts respectively connecting the image forming unit and the heating unit to the exhaust device and;
multiple shutters to respectively adjust an air volume of the air exhausted through the multiple exhaust ducts; and
circuitry configured to:
control each of the multiple shutters to change an opening size of corresponding one of the multiple shutters based on the operation state detected by the detector; and
control the exhaust device to change the air volume based on the operation state.

12. A liquid discharge method comprising:
causing multiple liquid discharge apparatuses to discharge a liquid;
detecting an operation state of each of the multiple liquid discharge apparatuses;
exhausting air from each of the multiple liquid discharge apparatuses;
causing multiple shutters to respectively adjust an air volume of the air exhausted from the multiple liquid discharge apparatuses;
changing an opening size of each of the multiple shutters based on the operation state; and
changing the air volume based on the operation state.
